(19) United States
(12) Patent Application Publication
(10) Pub. No.: US 2015/0210202 A1
(43) Pub. Date: Jul. 30, 2015

(54) ATV Logging Accessory

(71) Applicant: James Williams, North Adams, MA (US)

(72) Inventor: James Williams, North Adams, MA (US)

(21) Appl. No.: 14/165,414

(22) Filed: Jan. 27, 2014

(51) Int. Cl. B60P 3/41; B66D 1/60; B62D 21/09

(52) U.S. Cl. CPC B60P 3/41; B62D 21/09; B66D 1/60

(57) ABSTRACT

An all terrain vehicle accessory operable to assist in the transportation of large objects such as but not limited to logs. The all terrain vehicle accessory includes a main support beam having a first portion and a second portion. The first portion and second portion of the main support beam are angularly secured to each other. The main support beam includes a first end configured to releasably secure to a portion of a frame of an all terrain vehicle. A mounting plate is secured to the second portion of the main support beam and has an electric winch motor mounted thereon. A support member is perpendicularly secured to the end of the second portion and includes an aperture to receive a cable therethrough. The aperture has rotatably mounted therearound four roller sleeves. Chains are secured to the main support beam and are operably coupled to the all terrain vehicle.

### PRIORITY UNDER 35 U.S.C Section 119(e) & 37 C.F.R. Section 1.78

This nonprovisional application claims priority based upon the following prior United States Provisional Patent Application entitled: ATV Logging Apparatus, Application No. 61/763406, filed Feb. 11, 2013, in the name of James Williams, which is hereby incorporated by reference for all purposes.

### FIELD OF THE INVENTION

The present invention relates generally to all terrain vehicle accessories, more specifically but not by way of limitation an all terrain vehicle accessory that is operable to assist in the transportation of logs.

### BACKGROUND

All terrain vehicles are extremely popular in the United States. Whether for recreational purposes or for work, all terrain vehicles provide a means to accomplish certain tasks that traditional vehicles cannot accomplish. All terrain vehicles are typically four wheel drive compact vehicles that can more easily be driven through harsh terrain such as but not limited to dense woods or swamp. The all terrain vehicle is also popular for hunting and camping as its ability to penetrate areas that can not be accessed by traditional vehicles make it an excellent vehicle to transport hunters and campers to areas that have traditionally been difficult to access.

One issue with conventional all terrain vehicles and their frames is the lack of support structure required to perform additional tasks other than transporting individuals. While most conventional all terrain vehicles are configured with racks to carry items such as but not limited to bags or firearms, the frame structure of a conventional all terrain vehicle does not provide the required structure to transport other items. Another issue with conventional all terrain vehicles and their frames is their lack of components configured to traverse objects across a desired terrain. While many all terrain vehicles are configured with a conventional ball hitch operable to be coupled with a trailer or other device having a mateable tongue, conventional all terrain vehicle frames lack the support structure to engage articles of different size and type so as to transport or move these articles.

Accordingly, there is a need for an all terrain vehicle accessory that is operable to be coupled with an all terrain vehicle frame that is configured to attach to and subsequently move objects such as but not limited to logs.

### SUMMARY OF THE INVENTION

It is the object of the present invention to provide an all terrain vehicle accessory that is operable to assist in the transportation of a large object.

Another object of the present invention is to provide an all terrain vehicle accessory that is operably coupled with the frame thereof that includes a main support beam.

A further object of the present invention is to provide an all terrain vehicle accessory operable to coupled to the frame proximate the rear axle wherein the main support beam includes a first portion and a second portion angularly contiguous with each other.

Still another object of the present invention is to provide an all terrain vehicle accessory operable to couple to a frame of an all terrain vehicle that includes a support bar extending intermediate the first portion and second portion of the main support beam.

An additional object of the present invention is to provide an all terrain vehicle accessory operable to transport large objects that includes a mounting plate secured to the top of the second portion of the main support beam.

Another object of the present invention is to provide an all terrain vehicle accessory configured to assist in the transportation of large objects that further includes a perpendicular member secured to the second portion of the main support beam distal to the first portion.

Yet a further object of the present invention is to provide an all terrain vehicle accessory operable to transport logs wherein the perpendicular support member includes an aperture surrounded by rolling members.

Still a further object of the present invention is to provide an all terrain vehicle accessory operable to assist in the transportation of large objects that further includes an mounting plate and a winch operably coupled thereto.

An additional object of the present invention is to provide an all terrain vehicle operable to assist in transporting large objects that includes a plurality of stabilizing chains.

To the accomplishment of the above and related objects the present invention may be embodied in the form illustrated in the accompanying drawings. Attention is called to the fact that the drawings are illustrative only. Variations are contemplated as being a part of the present invention.

### BRIEF DESCRIPTION OF THE DRAWINGS

A more complete understanding of the present invention may be had by reference to the following Detailed Description when taken in conjunction with the accompanying Drawings wherein the drawings provide views of a preferred embodiment of the present invention only and do not serve to limit the scope of the present invention:

FIG. 1 is a view of the second end of the present invention; and

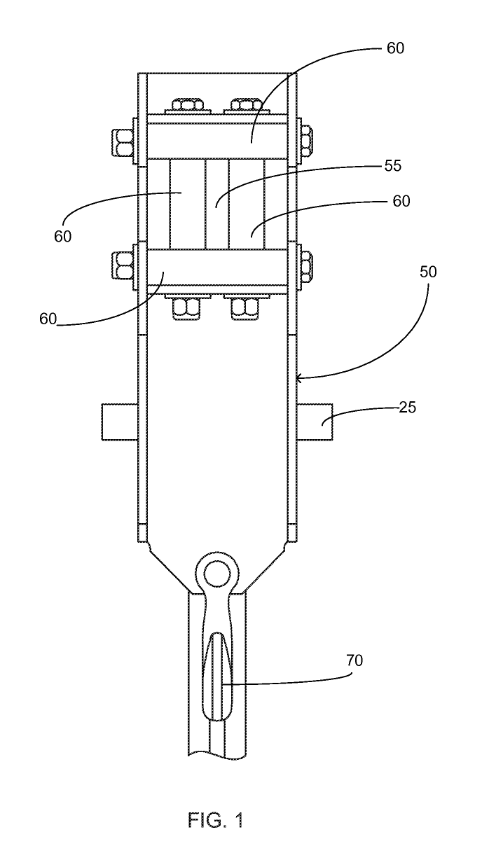

FIG. 2 is a side view of the present invention; and

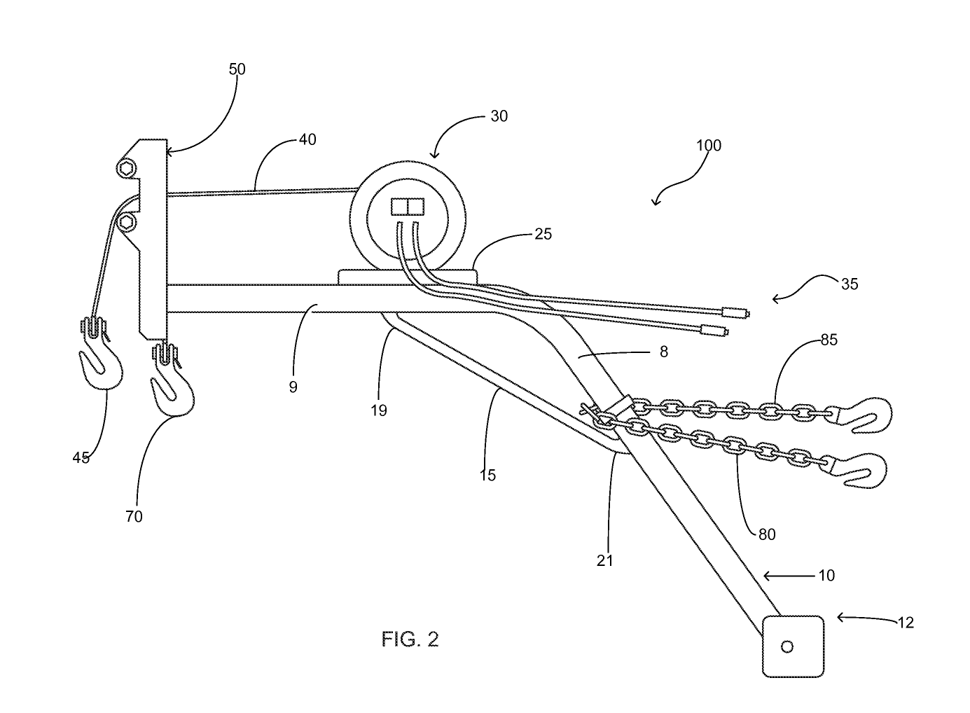

FIG. 3 is a perspective view of the present invention coupled with an exemplary all terrain vehicle frame.

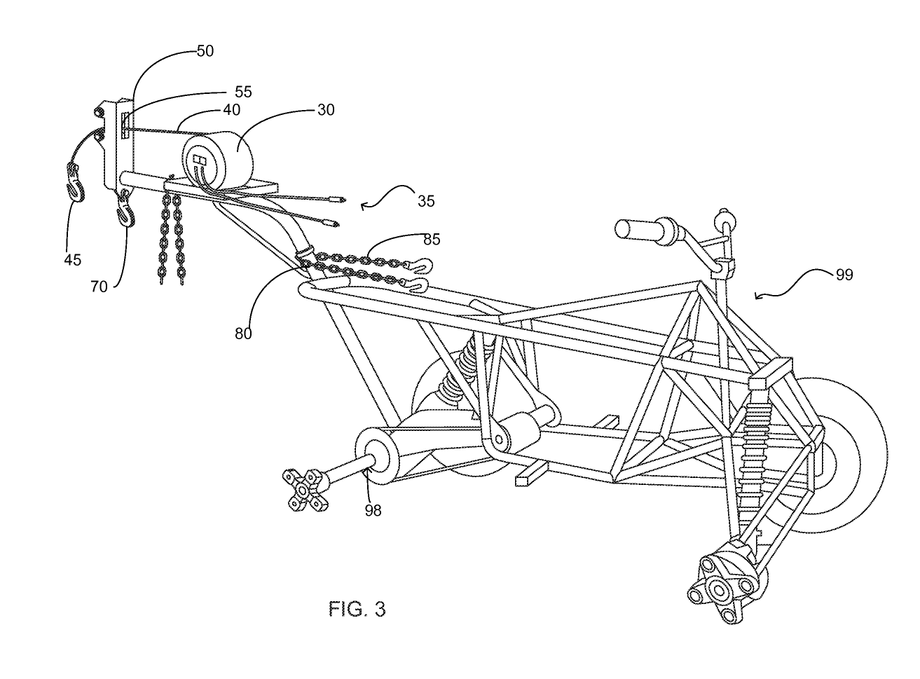

### DETAILED DESCRIPTION

Referring now to the drawings submitted herewith, wherein various elements depicted therein are not necessarily drawn to scale and wherein through the views and figures like elements are referenced with identical reference numerals, there is illustrated a all terrain vehicle accessory 100 constructed according to the principles of the present invention.

The all terrain vehicle accessory 100 includes a main support beam 10 that is elongated in manner and manufactured from a suitable durable material such as but not limited to metal. The main support beam 10 includes a first portion 8 and a second portion 9. In a preferred embodiment the main support beam 10 is manufactured from metal tubing. Those skilled in the art will recognize that numerous sizes and shapes of material could be used to manufacture the main support beam 10. The main support beam 10 includes a first end 12 that is configured to releasably secure to an all terrain vehicle frame 99. The first end 12 is secured proximate the rear axle 98 of the all terrain vehicle frame 99. It is contemplated within the scope of the present invention that the first end 12 could be configured in numerous different manners so as to releasably attached to the all terrain vehicle frame 99. By way of example but not by way of limitation, the first end 12 could be configured with a rod or similar element that would be operable to journal into a hole of a hitch receiver mounted to the all terrain vehicle frame 99. Alternatively, the first end 12 could have mounted thereon additional mounting plates or the like that would facilitate the operable coupling of the main support beam 10 to the all terrain vehicle frame 99.

The second portion 9 of the main support beam 10 is contiguous with the first portion 8 and angular thereto. Subsequent the all terrain vehicle accessory 100 being mounted to the all terrain vehicle frame 99 the main support beam 10 extends outward from the all terrain vehicle frame 99 wherein the second portion 9 is generally horizontal with respect to the ground. A brace 15 extends across the angle 18 and functions to provide additional structural support for the main support beam 10. The brace 15 is manufactured from a suitable durable material such as but not limited to metal. The first end 19 and second end 21 of the brace 15 are secured to the second portion 9 and first portion 8 of the main support beam 10 utilizing suitable durable techniques such as but not limited to welding.

Superposed the second portion 9 is plate member 25. Plate member 25 is generally square in shape and planar in manner being manufactured from a suitable durable material such as but not limited to metal. The plate member 25 functions as a mount for the motor 30. While no particular size of the plate member 25 is required good results have been achieved utilizing a plate member 25 that is approximately six inches by six inches. The plate member 25 is secured to the second portion 9 of the main support beam 10 utilizing suitable durable techniques such as but not limited to welding. While not particularly illustrated herein, the plate member 25 includes a plurality of apertures operable to receive mounting bolts or the like of numerous different sizes and styles of motors 30. It is contemplated within the scope of the present invention that any number of apertures and aperture patterns could be present in the plate member 25.

Mounted to the plate member 25 is the motor 30. The motor 30 is a conventional DC electric motor that includes a wiring harness 35 that operably coupled to the electrical system of the exemplary all terrain vehicle 95. The motor 30 is a winch style motor having a cable 40 operably coupled thereto wherein the cable 40 includes a hook 45. It is further contemplated within the scope of the present invention that the motor 30 could be electrically coupled to another power source in addition to the electrical system of the exemplary all terrain vehicle 95.

Mounted to the second portion 9 distal with respect to the plate member 25 is support member 50. The support member 50 is generally rectangular in shape and is manufactured from a suitable durable material such as but not limited to metal. The support member 50 is secured to the second portion 9 of the main support beam 10 utilizing suitable durable techniques such as but not limited to welding. The support member 50 includes aperture 55. The aperture 55 functions to allow the cable 40 to pass therethrough in order to provide desired positioning thereof. The aperture 55 has surroundably mounted on each side thereof roller sleeves 60. The roller sleeves 60 are rotatably mounted proximate the aperture 55 utilizing bolts 65. The roller sleeves 60 function to provide support for the cable 40 and substantially inhibit damage thereto. The roller sleeves 60 are positioned on all four sides of the aperture 55 to ensure minimization of damage will occur to the cable 40 regardless of its position within the aperture 55. Secured to the support member 50 is hook 70. Hook 70 is a conventional metal hook and is operable to assist in releasably securing an object to the all terrain vehicle accessory 100 for movement thereof. It is contemplated within the scope of the present invention that more than one hook 70 could be utilized. Additionally, it is further contemplated within the scope of the present invention that other types of mechanical fasteners could be used in place of and/or in conjunction with the hook 70.

Secured to the first portion 8 of the main support beam 10 is a first chain 80 and a second chain 85. The first chain 80 and second chain 85 are secured to the first portion 9 utilizing suitable durable techniques. The first chain 80 and second chain 85 are conventional metal chains and are operable to attach to a portion of the all terrain vehicle frame 99 and function to provide additional stability and support for the all terrain vehicle accessory 100 when in use moving large objects. It is contemplated within the scope of the present invention that any number of chains could be utilized. Furthermore, it is contemplated within the scope of the present invention that other suitable materials could be utilized in place of and/or in conjunction with the first chain 80 and second chain 85. More specifically but not by way of limitation, cables or other similar materials could be used for stabilizing the main support beam 10.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the present invention.

What is claimed is:

1. An all terrain vehicle accessory comprising:
a main support beam, said main support beam having a first portion and a second portion, said main support beam including a first end and a second end, said first portion and said second portion of said main support beam being angular with respect to each other;
a mounting plate, said mounting plate being secured to said second portion of said main support beam, said mounting plate being generally square in shape;
a support member, said support member being mounted to said second portion of said main support beam distal to said mounting plate, said support member being perpendicular to said second portion, said support member further including an aperture; and
wherein the all terrain vehicle accessory is operably coupled to a frame of a conventional all terrain vehicle in order to transport large objects.

2. The all terrain vehicle accessory as recited in claim 1, and further including a plurality of roller sleeves, said roller sleeves being surroundably mounted around said aperture of said support member.

3. The all terrain vehicle accessory as recited in claim 2, and further including a brace member, said brace member being mounted intermediate said first portion and said second portion of said main support beam.

4. The all terrain vehicle accessory as recited in claim 3, wherein said first end of said main support beam is configured to be releasably secured to a frame of an all terrain vehicle.

5. The all terrain vehicle accessory as recited in claim 4, and further including at least one fastener, said at least one fastener being secured to said support member.

6. The all terrain vehicle accessory as recited in claim 5, further including at least one stabilizer, said at least one stabilizer being secured to said first portion of said main support beam, said at least one stabilizer being operable to secure to a portion of a frame of an all terrain vehicle.

7. The all terrain vehicle accessory as recited in claim 6, and further including an electric motor, said electric motor being superposed said mounting plate.

8. An all terrain vehicle accessory operable to assist a user in moving large objects comprising:
a support beam, said support beam being rod shaped, said support beam having a first portion and a second portion, said support beam including a first end and a second end, said first end being configured to be releasably secured to a frame of an all terrain vehicle, said first portion and said second portion of said support beam being angular with respect to each other;
a mounting plate, said mounting plate being secured to said second portion of said support beam, said mounting plate being generally square in shape;
a support member, said support member being mounted to said second end of said support beam, said support member being perpendicular to said second portion, said support member further including an aperture, said aperture being square in shape; and
at least one chain, said at least one chain having a first end and a second end, said at least one chain being secured to said first portion of said support beam at said first end, said second end of said at least one chain being operable to secure to a portion of a frame of an all terrain vehicle; and
wherein the support beam extends away from an all terrain vehicle subsequent to being coupled thereto.

9. The all terrain vehicle accessory as recited in claim 8, and further including a plurality of roller sleeves, said roller sleeves being rotatably mounted proximate said aperture of said support member.

10. The all terrain vehicle accessory as recited in claim 9, and further including a support brace, said support brace extending intermediate said first portion and said second portion of said support beam.

11. The all terrain vehicle accessory as recited in claim 10, wherein said mounting plate is approximately six inches by six inches in size.

12. The all terrain vehicle accessory as recited in claim 11, and further including an electric winch motor, said electric winch motor further including a cable, said electric winch motor further having a wiring harness operable to couple with a power source.

13. The all terrain vehicle accessory as recited in claim 12, and further including a hook, said hook being mounted to said support member, said hook being generally underneath said aperture of said support member.

14. The all terrain vehicle accessory as recited in claim 13, wherein the all terrain vehicle is operable to assist in the transportation of large logs.

15. An all terrain vehicle accessory operably coupled to the rear of a frame of an all terrain vehicle that is operable to assist in the transportation of large objects comprising:
a support beam, said support beam being rod shaped, said support beam having a first portion and a second portion, said support beam including a first end and a second end, said second portion being generally horizontal in manner, said first end being configured to be releasably secured to a frame of an all terrain vehicle, said first portion and said second portion of said support beam being angular with respect to each other;
a mounting plate, said mounting plate being secured to said second portion of said support beam, said mounting plate being generally square in shape;
a support member, said support member being mounted to said second end of said support beam, said support member being perpendicular to said second portion, said support member further including a square aperture, said square aperture having four sides forming a perimeter edge of the square aperture; and
a first stabilizer and a second stabilizer, said first stabilizer and a second stabilizer having a first end and a second end, said first stabilizer and a second stabilizer being secured to said first portion of said support beam at said first end, said second end of said first stabilizer and a second stabilizer being operable to secure to a portion of a frame of an all terrain vehicle.

16. The all terrain vehicle accessory as recited in claim 15, and further including four roller sleeves, said four roller sleeves being rotatably mounted to said support member proximate said perimeter edge of said square aperture, said four roller sleeves being cylindrical in shape, said four roller sleeves functioning to engage a cable journaled through said square aperture in order to inhibit damage thereto.

17. The all terrain vehicle accessory as recited in claim 16, and further including an electric winch motor, said electric winch motor further including a cable, said electric winch motor further having a wiring harness operable to couple with a power source.

18. The all terrain vehicle accessory as recited in claim 17, and further including a hook, said hook being mounted to said support member, said hook being generally underneath said square aperture of said support member.

19. The all terrain vehicle accessory as recited in claim 18, and further including a support brace, said support brace extending intermediate said first portion and said second portion of said support beam.

20. The all terrain vehicle accessory as recited in claim 19, wherein the first portion of the support beam angularly extends outward and away from an all terrain vehicle when mounted thereto and wherein the second portion of the support beam is parallel with respect to a ground on which the all terrain vehicle is superposed.
